(19) United States
(12) Patent Application Publication
(10) Pub. No.: US 2014/0195325 A1
(43) Pub. Date: Jul. 10, 2014

(54) CREDIT CARD AND SERVICE ORGANIZATION COOPERATIVE PROGRAM

(71) Applicant: Pietro G. Denevi, Los Gatos, CA (US)

(72) Inventor: Pietro G. Denevi, Los Gatos, CA (US)

(21) Appl. No.: 13/735,928

(22) Filed: Jan. 7, 2013

(51) Int. Cl. G06Q 30/02

(52) U.S. Cl. CPC G06Q 30/0279
USPC 705/14.34

(57) ABSTRACT

A user is issued a special credit card by a credit card company or the like. Participating merchants offer discounts on transactions completed using the special credit card; those discounts are not available for transactions involving other credit cards. The transaction history for the special credit card is monitored and, once a condition is satisfied, a rebate is provided by the credit card company. The rebate is not provided to the credit card user. Instead, the rebate is provided to a non-profit service organization that, in turn, administers distribution of the rebate to a non-profit or charitable organization specified by the credit card user. For example, a user can designate a specific school (e.g., the local elementary school) to receive the rebate.

### BACKGROUND

One of the most significant issues facing schools today is a lack of adequate funding. As state and local budgets are squeezed, the amount of money that is available for schools is being reduced. As a result, teachers are being laid off, increasing class sizes; programs are being cut; instructional materials are becoming less available; and facilities are not being as well maintained.

Increasing taxes and/or issuing school bonds are a couple of the traditional approaches taken by state governments to address shortfalls in the educational budget. However, those types of measures usually require voter approval, and many voters are reluctant to approve raising taxes or selling bonds. In some states, such as California, a two-thirds vote is needed to raise taxes, making it even less likely that a tax increase would pass.

Consequently, a novel approach for raising money for schools would be of great benefit.

### SUMMARY

Embodiments of the present disclosure provide a novel approach for raising money, for schools in particular and for other types of organizations in general. In one embodiment, a user is issued a special credit card by a credit card company or the like. In many respects, the special credit card is like any other credit card except it also has the advantages about to be described. Participating merchants offer discounts on transactions completed using the special credit card; those discounts are not available for transactions involving other credit cards. The transaction history for the special credit card is monitored and, once a condition is satisfied, a rebate is provided by the credit card company. For example, if the dollar amount of all purchases exceeds a certain amount, and/or if the total number of purchases exceeds a certain number, and/or if the dollar amount of purchases made on a periodic basis (e.g., each month) exceeds a certain amount, then the rebate is issued.

Significantly, the rebate is not provided to the credit card user, as is conventionally the case. Instead, the rebate is provided to a non-profit service organization that, in turn, administers distribution of the rebate to a non-profit or charitable organization specified by the credit card user. Alternatively, the rebate can be distributed directly to a non-profit or charitable organization specified by the credit card user. For example, in either case, a user can designate a specific school (e.g., the local elementary school) or related organization (e.g., the school's parent-teacher association) to receive the rebate.

Embodiments according to the present invention offer a number of advantages to each of the parties involved. The issuing credit card company will likely see significant use of the special credit card, which benefits that company because, according to conventional practice, they receive a fee or the like for each purchase. Participating merchants, although offering a discount, will likely experience increased business from customers eager to contribute to the school or organization of their choice. Participating merchants can be identified in some public way, for example, by displaying a sign or something similar in their store and on their Web site. Such a display promotes customer goodwill, serves as additional advertising, and provides an advantage over competitors who are not participants in the program.

The credit card users, although not receiving the rebate themselves, will likely earn more than the value of the rebate in the exclusive discounts available only to them. To cover costs of administering distribution of the rebates, the intermediate non-profit service organization can charge or receive a fee for each special credit card that is issued, and/or can receive a fee from each participating merchant, and/or can accept a commensurate portion of the rebates. Last but not least, schools receive the additional funding they need, without the need for increasing taxes and/or issuing bonds.

These and other objects and advantages of the various embodiments of the present disclosure will be recognized by those of ordinary skill in the art after reading the following detailed description of the embodiments that are illustrated in the various drawing figures.

### BRIEF DESCRIPTION OF THE DRAWINGS

The accompanying drawings, which are incorporated in and form a part of this specification and in which like numerals depict like elements, illustrate embodiments of the present disclosure and, together with the description, serve to explain the principles of the disclosure.

FIG. 1 is a block diagram of an example of a computing system capable of implementing embodiments according to the present disclosure.

FIG. 2 is a block diagram showing elements in a system for performing a credit card and service organization cooperative program in embodiments according to the present disclosure.

FIG. 3 is a block diagram showing the flow of funds between elements in a system for performing a credit card and service organization cooperative program in embodiments according to the present disclosure.

FIGS. 4, 5, and 6 illustrate flowcharts of computer-implemented methods for performing a credit card and service organization cooperative program in embodiments according to the present disclosure.

FIG. 7 illustrates an example of a logo that can be used to represent a credit card and service organization cooperative program in embodiments according to the present disclosure.

### DETAILED DESCRIPTION

Reference will now be made in detail to the various embodiments of the present disclosure, examples of which are illustrated in the accompanying drawings. While described in conjunction with these embodiments, it will be understood that they are not intended to limit the disclosure to these embodiments. On the contrary, the disclosure is intended to cover alternatives, modifications and equivalents, which may be included within the spirit and scope of the disclosure as defined by the appended claims. Furthermore, in the following detailed description of the present disclosure, numerous specific details are set forth in order to provide a thorough understanding of the present disclosure. However, it will be understood that the present disclosure may be practiced without these specific details. In other instances, well-known methods, procedures, components, and circuits have not been described in detail so as not to unnecessarily obscure aspects of the present disclosure.

Some portions of the detailed descriptions that follow are presented in terms of procedures, logic blocks, processing, and other symbolic representations of operations on data bits within a computer memory. These descriptions and representations are the means used by those skilled in the data processing arts to most effectively convey the substance of their work to others skilled in the art. In the present application, a procedure, logic block, process, or the like, is conceived to be a self-consistent sequence of steps or instructions leading to a desired result. The steps are those utilizing physical manipulations of physical quantities. Usually, although not necessarily, these quantities take the form of electrical or magnetic signals capable of being stored, transferred, combined, compared, and otherwise manipulated in a computing system. It has proven convenient at times, principally for reasons of common usage, to refer to these signals as transactions, bits, values, elements, symbols, characters, samples, pixels, or the like.

It should be borne in mind, however, that all of these and similar terms are to be associated with the appropriate physical quantities and are merely convenient labels applied to these quantities. Unless specifically stated otherwise as apparent from the following discussions, it is appreciated that throughout the present disclosure, discussions utilizing terms such as “receiving,” “accessing,” “issuing,” “forwarding,” “applying,” “sending,” “assigning,” “completing” “determining,” “transmitting,” “associating,” or the like, refer to actions and processes (e.g., flowcharts 400, 500, and 600 of FIGS. 4, 5, and 6, respectively) of a computing system or similar electronic computing device or processor (e.g., system 100 of FIG. 1). The computing system or similar electronic computing device manipulates and transforms data represented as physical (electronic) quantities within the computing system memories, registers or other such information storage, transmission or display devices.

Embodiments described herein may be discussed in the general context of computer-executable instructions residing on some form of computer-readable storage medium, such as program modules, executed by one or more computers or other devices. By way of example, and not limitation, computer-readable storage media may comprise non-transitory computer-readable storage media and communication media; non-transitory computer-readable media include all computer-readable media except for a transitory, propagating signal. Generally, program modules include routines, programs, objects, components, data structures, etc., that perform particular tasks or implement particular abstract data types. The functionality of the program modules may be combined or distributed as desired in various embodiments.

Computer storage media includes volatile and nonvolatile, removable and non-removable media implemented in any method or technology for storage of information such as computer-readable instructions, data structures, program modules or other data. Computer storage media includes, but is not limited to, random access memory (RAM), read only memory (ROM), electrically erasable programmable ROM (EEPROM), flash memory or other memory technology, compact disk ROM (CD-ROM), digital versatile disks (DVDs) or other optical storage, magnetic cassettes, magnetic tape, magnetic disk storage or other magnetic storage devices, or any other medium that can be used to store the desired information and that can accessed to retrieve that information.

Communication media can embody computer-executable instructions, data structures, and program modules, and includes any information delivery media. By way of example, and not limitation, communication media includes wired media such as a wired network or direct-wired connection, and wireless media such as acoustic, radio frequency (RF), infrared and other wireless media. Combinations of any of the above can also be included within the scope of computer-readable media.

FIG. 1 is a block diagram of an example of a computing system 100 capable of implementing embodiments according to the present disclosure. Computing system 100 broadly represents any single or multi-processor computing device or system capable of executing computer-readable instructions. Examples of computing system 100 include, without limitation, a laptop, tablet, or handheld computer. Computing system 100 may also be a type of computing device such as a cell phone, smart phone, media player, or the like.

In its most basic configuration, computing system 100 may include at least one processor 102 and at least one memory 104. Processor 102 generally represents any type or form of processing unit capable of processing data or interpreting and executing instructions. In certain embodiments, processor 102 may receive instructions from a software application or module. These instructions may cause processor 102 to perform the functions of one or more of the example embodiments described and/or illustrated herein.

Memory 104 generally represents any type or form of volatile or non-volatile storage device or medium capable of storing data and/or other computer-readable instructions. In certain embodiments computing system 100 may include both a volatile memory unit (such as, for example, memory 104) and a non-volatile storage device (not shown).

Computing system 100 also includes a display device 106 that is operatively coupled to processor 102. Display device 106 is generally configured to display a graphical user interface (GUI) that provides an easy to use interface between a user and the computing system.

Computing system 100 also includes an input device 108 that is operatively coupled to processor 102. Input device 108 may include a touch sensing device (a touch screen) configured to receive input from a user's touch and to send this information to the processor 102. Processor 102 interprets the touches in accordance with its programming.

Input device 108 may be integrated with display device 106 or they may be separate components. In the illustrated embodiment, input device 108 is a touch screen that is positioned over or in front of display device 106. Input device 108 and display device 106 may be collectively referred to herein as touch screen display 107.

Communication interface 122 of FIG. 1 broadly represents any type or form of communication device or adapter capable of facilitating communication between example computing system 100 and one or more additional devices. For example, communication interface 122 may facilitate communication between computing system 100 and a private or public network including additional computing systems. Examples of communication interface 122 include, without limitation, a wired network interface (such as a network interface card), a wireless network interface (such as a wireless network interface card), a modem, and any other suitable interface. In one embodiment, communication interface 122 provides a direct connection to a remote server via a direct link to a network, such as the Internet. Communication interface 122 may also indirectly provide such a connection through any other suitable connection. Communication interface 122 may also represent a host adapter configured to facilitate communication between computing system 100 and one or more additional network or storage devices via an external bus or communications channel.

As illustrated in FIG. 1, computing system 100 may also include at least one input/output (I/O) device 110. I/O device 110 generally represents any type or form of input device capable of providing/receiving input or output, either computer- or human-generated, to/from computing system 100. Examples of I/O device 110 include, without limitation, a keyboard, a pointing or cursor control device (e.g., a mouse), a speech recognition device, or any other input device.

Many other devices or subsystems may be connected to computing system 100. Conversely, all of the components and devices illustrated in FIG. 1A need not be present to practice the embodiments described herein. The devices and subsystems referenced above may also be interconnected in different ways from that shown in FIG. 1. Computing system 100 may also employ any number of software, firmware, and/or hardware configurations. For example, the example embodiments disclosed herein may be encoded as a computer program (also referred to as computer software, software applications, computer-readable instructions, or computer control logic) on a computer-readable medium.

The computer-readable medium containing the computer program may be loaded into computing system 100. All or a portion of the computer program stored on the computer-readable medium may then be stored in memory 104. When executed by processor 102, a computer program loaded into computing system 100 may cause processor 102 to perform and/or be a means for performing the functions of the example embodiments described and/or illustrated herein. Additionally or alternatively, the example embodiments described and/or illustrated herein may be implemented in firmware and/or hardware.

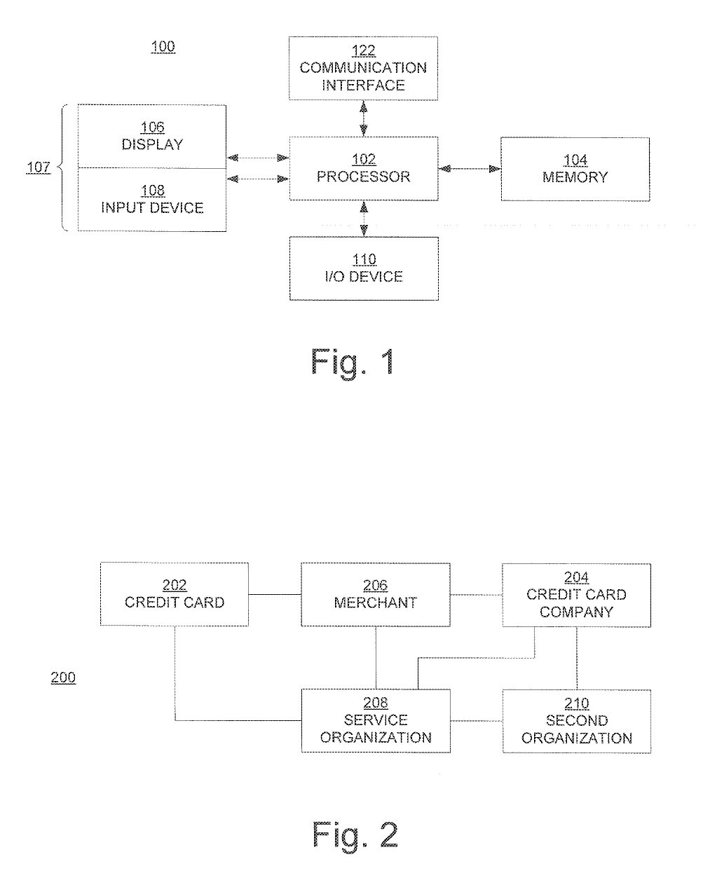

FIG. 2 is a block diagram showing elements in a system 200 for performing a credit card and service organization cooperative program in embodiments according to the present disclosure. In the example of FIG. 2, the system includes a credit card 202 (associated with a credit card user), a credit card company 204, a merchant 206, a service organization 208, and a second organization 210. The system 200 may also include a parent organization (not shown) (e.g., a corporate sponsor) that can help defray startup and administrative costs. The various elements can communicate with each other electronically, directly (e.g., face-to-face) or remotely, using wired or wireless systems, over phone lines or the Internet.

The credit card 202 can be implemented in a variety of different ways. For example, the credit card 202 may be embodied in the well-known form that has been in use for years (e.g., as a plastic card). Alternatively, the credit card 202 may be embodied in a more contemporary form. For example, the credit card 202 may be implemented as an application executing on a smart phone or similar portable electronic device, which is exemplified by the computing system 100 of FIG. 1.

Returning to the discussion of FIG. 2, the credit card 202 can be used to purchase goods and services in a conventional manner, but it is particularly tied to the credit card and service organization cooperative program, as will be described. Other features of the credit card 202, particularly those associated with the credit card and service organization cooperative program, are also described below.

In the example of FIG. 2, the credit card company 204 represents an entity that is responsible for issuing and administering the credit card 202. The credit card company 204 may be a bank, for example, although the present invention is not so limited. The credit card 202 user need not have any affiliation with the credit card company 204 other than the credit card. Thus, for example, if the user does business with a bank other than the bank that issued the credit card 202, the user can continue to do so and still be issued the credit card.

The credit card company 204 can, for instance, perform credit checks to identify qualified users, issue monthly statements showing charges made, and receive and apply payments and credits. Other services provided by the credit card company 204, particularly those associated with the credit card and service organization cooperative program, are described below.

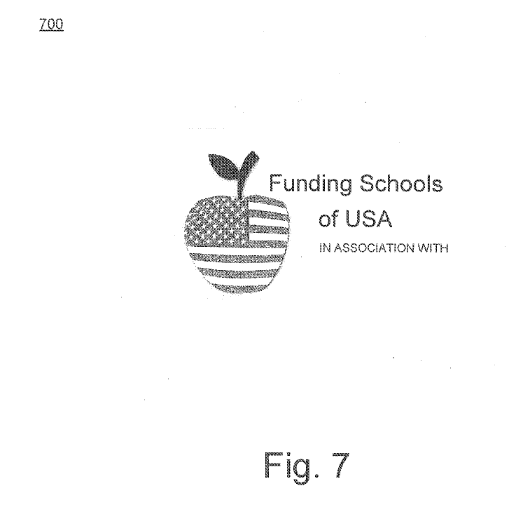

Note that a user does not necessarily have to use the credit card 202 to participate in the credit card and service organization cooperative program. For example, “First Bank” may issue a credit card 202 that is particularly tied to (e.g., partnered with) the credit card and service organization cooperative program as described above, but someone who wishes to participate in the cooperative program may have another credit card issued by “Second Bank.” The participant can affix a sticker (see FIG. 7) to the Second Bank credit card so that the Second Bank credit card can be used in the same manner as the credit card 202 issued by First Bank. Thus, the credit card 202 issued by the credit card company 204 for the credit card and service organization cooperative program, and another credit card issued by some other entity, can be equivalently used in the cooperative program. Second Bank can be compensated in some way for providing services on behalf of the credit card and service organization cooperative program. In this manner, the pool of participants in the cooperative program can be readily expanded.

In the example above, First Bank may be partnered with the credit card and service organization cooperative program as noted. Second Bank, on the other hand, can apply for and be accepted as an associate with the credit card and service organization cooperative program. Other banks and financial institutions that issue credit cards can be similarly approved to participate in the program as associates. In essence, a list of approved associates can be maintained, and associates can be added to or removed from that list.

FIG. 7 illustrates an example of a logo 700 that can be used to represent a credit card and service organization cooperative program in embodiments according to the present disclosure. The logo 700 may be printed on the credit card 202 (e.g., as background, or as an icon in the corner of the card), it may be affixed to the credit card 202 particularly associated with the cooperative program, or it may be affixed to another credit card as described above.

The merchant 206 of FIG. 2 represents an entity that sells goods and/or services. The merchant 206 may be, for example, a traditional “brick and mortar” store, an online enterprise (e.g., where purchases are made over the Internet), and/or a catalogue-based business (e.g., where purchases are made from a catalogue over the phone). Other services provided by the merchant 206, particularly those associated with the credit card and service organization cooperative program, are described below.

The service organization 208 is, in one embodiment, a local or national non-profit organization such as the Rotary Club. Such organizations are selected for the credit card and service organization cooperative program because, in general, they are already accepted and respected in the community, and have experience with and a long-standing commitment to providing time, effort, and money to community improvement programs. Furthermore, such organizations are also likely to have an existing account that satisfies section 501(c)(3) of the Internal Revenue Code, the significance of which is discussed further below. Also discussed below are other services provided by the service organization 208, particularly those associated with the credit card and service organization cooperative program.

The second organization 210 is, in general, a non-profit organization that is the intended recipient of charitable donations made through the credit card and service organization cooperative program. In one embodiment, the second organization is a school or an organization associated with the school, such as a parent-teacher association. A “school” may be, but is not limited to, a public or private school, for primary or secondary education, and includes colleges, universities, and trade schools.

In operation, the various elements in the system 200 work together as follows. A qualified user obtains a credit card 202 from the credit card company 204, where the credit card 202 is particularly associated with the credit card and service organization cooperative program. Alternatively, the service organization 208 contracts with the credit card company 204 for some number of such credit cards, then distributes those cards to qualified users. The process for qualifying users is not described herein, but can be readily accomplished by an interested party through any of the well-known credit bureaus. As another alternative, a sticker is affixed to an existing credit card, to associate that credit card with the credit card and service organization cooperative program,

The user may be asked to pay a one-time or annual fee to use the credit card 202, in addition to any fees charged by the credit card company 204. Such a fee can be collected by the service organization 208 and used to defray costs associated with implementing and administering the credit card and service organization cooperative program. If the fees collected by users exceed costs, the extra amount can serve as the source for additional funding for the second organization 210 or for some other program conducted by the service organization 208. In other words, the fees collected by essentially selling the credit card 202 provide an additional source of funding for the various activities performed by the service organization 208, and thus can serve as inducement for the service organization to participate in the credit card and service organization cooperative program.

A rebate is associated with the credit card 202. The rebate may be in the form of cash, credit, or points. The rebate is earned based on how much the user uses the credit card 202. In general, the transaction history of the credit card 202 is monitored and, once a condition is satisfied, the rebate is provided by the credit card company 204. For example, if the dollar amount of all purchases exceeds a certain amount, and/or if the total number of purchases exceeds a certain number, and/or if the dollar amount of purchases made on a periodic basis (e.g., each month) exceeds a certain amount, then the rebate is issued. Other conditions may be applied.

The amount of the rebate can depend, for example, on the total amount or number of purchases. The amount of the rebate can grow as more purchases are made. Multiple rebates can be issued over the life of the credit card 202.

According to embodiments of the present disclosure, in order to acquire and use the credit card 202, the user of the credit card 202 is required to authorize dedication of the rebate to an organization of their choice (the second organization 210). More specifically, the user of the credit card 202 dedicates the rebate to a non-profit organization such as a school. The user can specify the particular organization (e.g., school) that is to receive the rebate. The user's choice can be stored and maintained by the credit card company 204 and/or the service organization 208 in account information for the credit card 202.

Thus, unlike conventional credit cards that provide a rebate to users, the rebate is not provided to the user and instead is provided to a non-profit organization specified by the user.

In one embodiment, the rebate is provided to the second organization 210 through the service organization 208. In one such embodiment, the rebate is transferred to the service organization 208 by the credit card company 204. In one such embodiment, the rebate is transferred to a section 501(c)(3) account of the service organization 208 in the form of a cash payment from the credit card company 204. In another embodiment, the rebate is provided directly to the second organization 210 by the credit card company 204.

The service organization 208, in turn, distributes the rebate to the second organization 210 designated by the user of the credit card 202. The user may designate more than one such organization, in which case the service organization 208 distributes the rebate accordingly. To cover administrative costs, the service organization 208 may hold back a commensurate portion of the rebates.

In order to induce the user of the credit card 202 to sign up for and use a credit card (the credit card 202) in which a fee may be involved and in which the user surrenders the rebate, merchants are asked to participate in the credit card and service organization cooperative program and provide discounts on transactions completed using the credit card 202, where those discounts are not available for transactions performed using other credit cards. The credit card user 202 users, although not receiving the rebate, will likely earn more than the value of the rebate in the exclusive discounts available only to them. The discounts can be negotiated and made known (e.g., advertised) in advance. Also, the discounts can remain effective for a prescribed period of time, to provide assurance to users that they will have time to collect discounts and offset the cost of the credit card 202.

A list of participating merchants (e.g., the merchant 206) and applicable discounts can be printed by the service organization 208 and included in material distributed to credit card 202 users by the credit card company 204, the service organization, and/or the second organization 210. For example, the list can be provided in school materials sent home with students at the beginning of the school year and routinely distributed to parents throughout the school year. An up-to-date list of participating merchants can also be made available through a link on the Web sites for the service organization 208 and the second organization 210. In addition, the merchant 206 can display information in their store, catalogue, and/or Web site indicating they are a participant in the credit card and service organization cooperative program. For example, the merchant 206 can receive a window sticker and/or a sticker that can be placed on a cash register or sales desk to indicate their participation. The logo 700 of FIG. 7 can be implemented as a window sticker or cash register sign, for example.

With reference again to FIG. 2, the merchant 206, although offering a discount, will likely experience increased business from customers eager to contribute to the school or organization of their choice. For example, a local restaurant may provide a ten percent discount if the credit card 202 is used on days that are less busy (e.g., weekdays), thus increasing the number of customers on those days without necessarily adversely impacting revenue from busier days (e.g., weekends). Regardless, given a choice between two similar merchants, a user of the credit card 202 is more likely to choose the merchant that is participating in the credit card and service organization cooperative program versus the merchant that is not, in order to generate a contribution to a second organization 210 of their choice and to take advantage of the exclusive discount available to them.

In one embodiment, the merchant 206 pays an advertising fee to the service organization 208, in order to help defray the costs of the service organization. As mentioned above, in return for such a fee, the merchant 206 receives advertising in addition to their normal advertising, in lists distributed to users and on Web sites and in the form of a sticker that can be displayed in the merchant's store and on their Web site. Furthermore, participation in the credit card and service organization cooperative program is expected to increase customer goodwill and provide an advantage over competitors who are not participants in the program. The advertising fee is expected to be relatively small, because the intent is to encourage merchants to participate in the credit card and service organization cooperative program. The advertising fee also serves as an inducement for the service organization 208 to participate in the program, by providing an additional source of funding for other activities supported by the service organization.

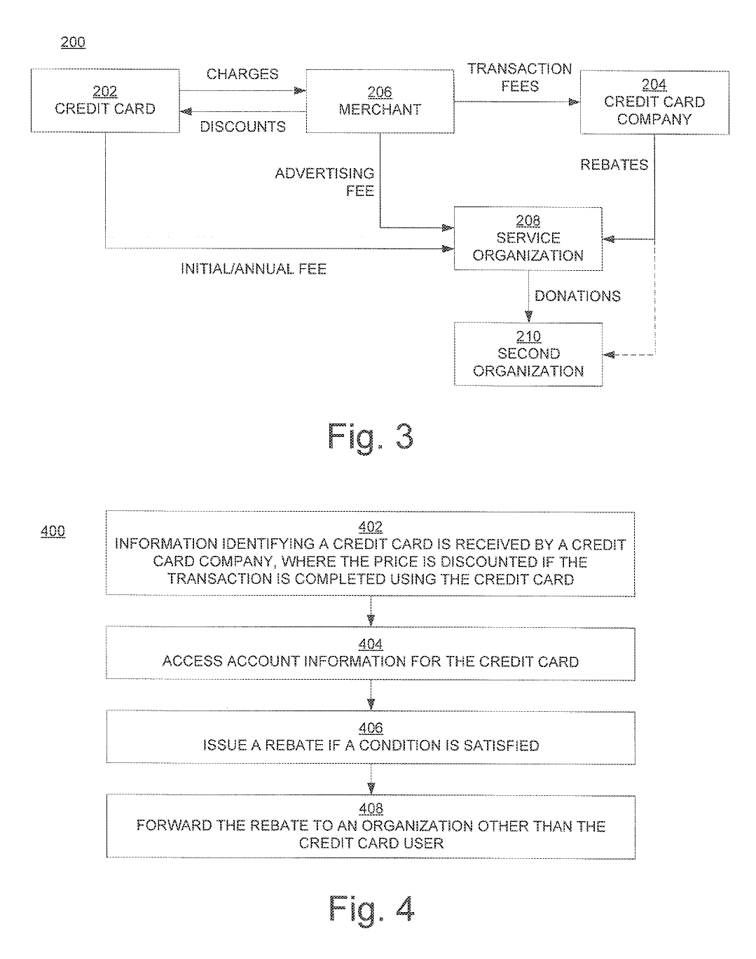

FIG. 3 is a block diagram showing the flow of funds between elements in the system 200 in embodiments according to the present disclosure. In the example of FIG. 3, the user of the credit card 202 may pay an initial or annual fee to the service organization 208 or to the credit card company 204 (the latter path is not shown). The merchant 206 receives credit for purchases made with the credit card 202, and provides discounts that are credited to the credit card or applied to the price of the purchases. The merchant 206 pays a transaction fee or the like to the credit card company 204. The merchant 206 may also pay an advertising fee to the service organization 208. The user of the credit card 202 pays the credit card company 204 for charges (not shown). The credit card company 204 issues rebates to the service organization 208, which makes donations based on the rebate to the second organization 210 (e.g., a school). Alternatively, the rebates may be made directly to the second organization 210 by the credit card company 204.

Not all exchanges of funds are shown in FIG. 3. For example, transactions from the credit card company 204 to the merchant 206, and payments to the credit card company 204, are not shown.

The discussion above refers to the use of the credit card 202. As noted previously herein, the credit card 202 may be a credit card issued particularly for the credit card and service organization cooperative program, or another credit card may be equivalently used by, for example, attaching a sticker (e.g., the logo 700 of FIG. 7).

FIGS. 4, 5, and 6 illustrate flowcharts of computer-implemented methods for performing a credit card and service organization cooperative program in embodiments according to the present disclosure. Each of the flowcharts/methods can be implemented as computer-executable instructions residing on some form of computer-readable storage medium (e.g., using computing system 100 of FIG. 1).

The flowchart 400 of FIG. 4 illustrates an example of a computer-implemented method from the perspective of the credit card company 204 of FIG. 2. The flowchart 500 illustrates an example of a computer-implemented method from the perspective of the merchant 206 of FIG. 2. The flowchart 600 illustrates an example of a computer-implemented method from the perspective of the service organization 208 of FIG. 2.

In block 402 of FIG. 4, information identifying a credit card is received by a credit card company as part of a transaction that includes a purchase of merchandise, in which the price of the merchandise is discounted if the transaction is completed using the credit card but not if the transaction is completed using some other credit card.

In block 404, account information is accessed for the credit card, where the account information includes a transaction history for the credit card.

In block 406, a rebate is issued by the credit card company if the account information (e.g., transaction history) satisfies a condition. The condition may be one or more of the following: a total value of purchases made with the credit card exceeds a threshold amount; a total number of purchases made with the credit card exceeds a threshold number; and an amount of purchases made on a periodic basis (e.g., a monthly basis) exceeds a threshold amount. The rebate can be issued in electronic form, for example, as an electronic funds transfer (EFT) transaction.

In block 408, the rebate is forwarded to a first organization instead of to a user/owner of the credit card. The rebate may be forwarded in electronic form. The first organization may be a service organization that administers distribution of the rebate to a second organization, specifically a second organization that is designated by the user of the credit card. Alternatively, the first organization may be the organization designated by the user of the credit card; that is, the “first organization” may be a school or a non-profit organization affiliated with a school, and the rebate may be distributed directly to the designated recipient instead of going through the service organization.

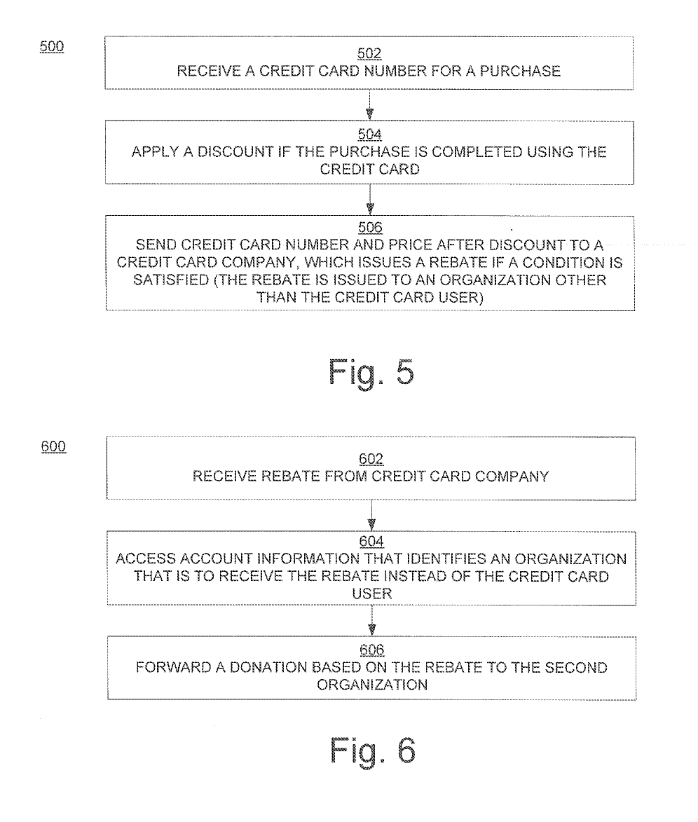

In block 502 of FIG. 5, a credit card number for a credit card is received by a merchant as part of a transaction that includes a purchase of merchandise. The credit card (e.g., credit card 202 of FIG. 2) is particularly tied to the credit card and service organization cooperative program described herein.

In block 504, a discount is applied to the purchase if the purchase is completed using the credit card, but not if the purchase is completed using another credit card. The discount might be applied to reduce the price of the merchandise, or it might be applied as a credit to the credit card.

In block 506, the credit card number and the price after the discount is sent to a first organization (e.g., a credit card company) with access to a transaction history for the credit card, which issues a rebate if the transaction history satisfies a condition. The rebate, which may be in electronic form, is forwarded to a second organization that is identified in account information for the credit card, instead of to the user/owner of the card. In a manner similar to that mentioned above, the second organization may be a service organization that administers distribution of the rebate to a third organization that is designated by the user of the credit card. Alternatively, the second organization may be the organization designated by the user of the credit card; that is, the “second organization” may be a school or a non-profit organization affiliated with a school, and the rebate may be distributed directly to the designated recipient instead of going through the service organization.

In block 602 of FIG. 6, a service organization receives a rebate from a credit card company. The rebate may be in electronic form. The rebate is associated with a credit card, where the rebate is surrendered to the service organization instead of being awarded to the user or credited to the credit card.

In block 604, account information for the credit card is accessed. The account information identifies the user of the credit card and/or designates a second organization (e.g., a school) that is to receive the rebate.

In block 606, the rebate, or an amount based on the amount of the rebate, is forwarded to the second organization, perhaps electronically.

In summary, embodiments according to the present disclosure provide a convenient way for people to give money to an organization of their choice, a school, for example. By partnering and integrating a credit card company, a service organization, and merchants, a self-sustaining program is created in which points or cash earned for credit card purchases are directed to an organization specified by the credit card's user. The credit card user, in turn, receives discounts for merchandise that might not otherwise be available.

While the foregoing disclosure sets forth various embodiments using specific block diagrams, flowcharts, and examples, each block diagram component, flowchart step, operation, and/or component described and/or illustrated herein may be implemented, individually and/or collectively, using a wide range of hardware, software, or firmware (or any combination thereof) configurations. In addition, any disclosure of components contained within other components should be considered as examples because different architectures can be implemented to achieve the same functionality.

The process parameters and sequence of steps described and/or illustrated herein are given by way of example only. For example, while the steps illustrated and/or described herein may be shown or discussed in a particular order, these steps do not necessarily need to be performed in the order illustrated or discussed. The various example methods described and/or illustrated herein may also omit one or more of the steps described or illustrated herein or include additional steps in addition to those disclosed.

While various embodiments have been described and/or illustrated herein in the context of fully functional computing systems, one or more of these example embodiments may be distributed as a program product in a variety of forms, regardless of the particular type of computer-readable media used to actually carry out the distribution. The embodiments disclosed herein may also be implemented using software modules that perform certain tasks. These software modules may include script, batch, or other executable files that may be stored on a computer-readable storage medium or in a computing system. These software modules may configure a computing system to perform one or more of the example embodiments disclosed herein. One or more of the software modules disclosed herein may be implemented in a cloud computing environment. Cloud computing environments may provide various services and applications via the Internet. These cloud-based services (e.g., software as a service, platform as a service, infrastructure as a service, etc.) may be accessible through a Web browser or other remote interface. Various functions described herein may be provided through a remote desktop environment or any other cloud-based computing environment.

The foregoing description, for purpose of explanation, has been described with reference to specific embodiments. However, the illustrative discussions above are not intended to be exhaustive or to limit the invention to the precise forms disclosed. Many modifications and variations are possible in view of the above teachings. The embodiments were chosen and described in order to best explain the principles of the invention and its practical applications, to thereby enable others skilled in the art to best utilize the invention and various embodiments with various modifications as may be suited to the particular use contemplated.

Embodiments according to the invention are thus described. While the present disclosure has been described in particular embodiments, it should be appreciated that the invention should not be construed as limited by such embodiments, but rather construed according to the below claims.

What is claimed is:

1. A computer system comprising:
a processor; and
memory coupled to the processor, the memory have stored therein instructions that, if executed by the computer system, cause the computer system to execute operations comprising:
receiving information identifying a credit card as part of a transaction comprising a purchase of merchandise having a price, wherein the price of the merchandise is discounted if the transaction is completed using the credit card;
accessing account information for the credit card, the account information comprising a transaction history for the credit card;
issuing a rebate if the account information satisfies a condition; and
forwarding the rebate to a first organization instead of to a user of the credit card.

2. The computer system of claim 1, wherein the first organization is a non-profit organization that administers distribution of the rebate to a second organization specified by the user of the credit card.

3. The computer system of claim 1, wherein the first organization is selected from the group consisting of: a school; and a non-profit organization affiliated with a school.

4. The computer system of claim 1, wherein the condition is selected from the group consisting of: a total value of purchases made with the credit card exceeds a threshold amount; a total number of purchases made with the credit card exceeds a threshold number; and an amount of purchases made on a periodic basis exceeds a threshold amount.

5. The computer system of claim 1, wherein the first organization provides advertising services for merchants that discount merchandise purchased using the credit card.

6. The computer system of claim 5, wherein the merchants provide a fee to the first organization in exchange for the advertising services.

7. The computer system of claim 1, wherein the first organization receives funds to cover administrative costs, the funds selected from the group consisting of: a fee that is charged to the user of the credit card; and a portion of the rebate.

8. A computer-readable storage medium having computer-executable instructions for causing a computing system to perform a method comprising:
receiving a credit card number for a credit card as part of a transaction comprising a purchase of merchandise having a price;
applying a discount to reduce the price of the merchandise if the purchase is completed using the credit card; and
sending the credit card number and the price after the discount to a first organization with access to a transaction history for the credit card, wherein a rebate is issued if the transaction history satisfies a condition, and wherein the rebate is forwarded to a second organization that is identified in account information for the credit card.

9. The computer-readable storage medium of claim 8, wherein the second organization administers distribution of the rebate to a third organization specified by the user of the credit card.

10. The computer-readable storage medium of claim 8, wherein the second organization is selected from the group consisting of: a school; and a non-profit organization affiliated with a school.

11. The computer-readable storage medium of claim 8, wherein the condition is selected from the group consisting of: a total value of purchases made with the credit card exceeds a threshold amount; a total number of purchases made with the credit card exceeds a threshold number; and an amount of purchases made on a periodic basis exceeds a threshold amount.

12. The computer-readable storage medium of claim 8, wherein the first organization provides advertising services for merchants that discount merchandise purchased using the credit card.

13. The computer-readable storage medium of claim 12, wherein the merchants provide a fee to the first organization in exchange for the advertising services.

14. The computer-readable storage medium of claim 8, wherein the first organization receives funds to cover administrative costs, the funds selected from the group consisting of: a fee that is charged to a user of the credit card; and a portion of the rebate.

15. A method comprising:
assigning a credit card to a user;
completing a transaction with a merchant using the credit card;
determining if the merchant is a participant in a program affiliated with a non-profit organization;
if the merchant is a participant in the program, then applying a discount to reduce an amount of the transaction and otherwise not applying the discount, wherein the discount is also not applied to transactions made using another credit card, wherein further a final amount of the transaction is transmitted from the merchant over a network to a network-connected organization with access to a transaction history for the credit card;
associating a rebate with the credit card if the transaction history satisfies a condition; and
forwarding the rebate to a non-profit organization designated by the user instead of to the user.

16. The method of claim 15, wherein the non-profit organization distributes the rebate to a second organization specified by the user of the credit card.

17. The method of claim 16, wherein the second organization is selected from the group consisting of: a school; and a non-profit organization affiliated with a school.

18. The method of claim 15, wherein the condition is selected from the group consisting of: a total value of purchases made with the credit card exceeds a threshold amount; a total number of purchases made with the credit card exceeds a threshold number; and an amount of purchases made on a periodic basis exceeds a threshold amount.

19. The method of claim 15, wherein the non-profit organization provides advertising services for merchants that discount merchandise purchased using the credit card, wherein the merchants provide a fee to the non-profit organization in exchange for the advertising services.

20. The method of claim 15, wherein the non-profit organization receives funds to cover administrative costs, the funds selected from the group consisting of: a fee that is charged to the user of the credit card; and a portion of the rebate.
